(19) United States
(12) Patent Application Publication
(10) Pub. No.: US 2007/0223240 A1
(43) Pub. Date: Sep. 27, 2007

(54) Auxiliary light assembly for a motorcycle

(76) Inventor: Clifton Brown, Glen Burnie, MD (US)

Correspondence Address: JAMES RAY & ASSOCIATES, 2640 PITCAIRN ROAD, MONROEVILLE, PA, 15146, US

(21) Appl. No.: 11/716,322

(22) Filed: Mar. 9, 2007

Related U.S. Application Data
(60) Provisional application No. 60/781,594, filed on Mar. 10, 2006.

(51) Int. Cl. B62K 11/00

(52) U.S. Cl. 362/473; 180/219

(57) ABSTRACT

The invention provides an auxiliary light assembly which is disposed on and secured to a predetermined portion of a motorcycle and which is operatively coupled to a source of voltage for illuminating a ground surface forward of the motorcycle being ridden with its front wheel elevated above the ground surface. A switch is operatively coupled to the light assembly for selectively supplying the voltage and terminating voltage supply. According to one embodiment, the present invention contemplates the use of a mercury switch which is mounted within the light assembly.

### CROSS-REFERENCE TO RELATED APPLICATIONS

This application is related to and claims priority from U.S. Provisional Patent Application Ser. No. 60/781,594 filed on Mar. 10, 2006.

### FIELD OF THE INVENTION

The present invention relates, in general, to auxiliary lights for a motorcycle and, more particularly, this invention relates to motorcycle auxiliary lights that provide the rider with visibility of a ground surface when the front wheel of the motorcycle is elevated above such ground surface.

### BACKGROUND OF THE INVENTION

As is generally well known, some motorcycle riders perform a maneuver by riding the motorcycle in a vertically inclined position, wherein its front wheel is elevated above the ground and wherein a longitudinal axis of such motorcycle is often oriented relative to the ground surface at an angle of up to 80 degrees. When the maneuver is performed between dusk and dawn, the riders lack visibility of the ground surface as the light beams generated by a headlight of the motorcycle is directed upwardly and does not illuminate the ground surface. Thus, the riders create hazardous conditions for themselves and others motorists.

### SUMMARY OF THE INVENTION

According to one embodiment, the invention provides an improvement for a motorcycle including a frame having a front fork and a rear fork, a front wheel rotatably supported on the front fork, a rear wheel rotatably supported on the rear fork and an engine supported on the frame. The improvement includes a light means which is disposed on and secured to a predetermined portion of the motorcycle and which is operatively coupled to a source of a predetermined voltage for illuminating a ground surface forward of the motorcycle being ridden with the front wheel elevated above the ground surface. A control means is provided for selectively activating and deactivating the light means.

According to another embodiment of the invention, there is provided an auxiliary light assembly for use on a motorcycle including a frame having a front fork and a rear fork, a front wheel rotatably supported on the front fork, a rear wheel rotatably supported on the rear fork and an engine supported on the frame. The auxiliary light assembly includes a housing having an open front end. A lens covers the open front end of the housing. A mirror reflector is installed in the housing. At least one light source is operatively positioned adjacent the open front end and is coupled to a source of a predetermined voltage. The light source is capable of generating a light beam and emitting the light beam along a light beam path upon supply of the predetermined voltage; A switch is operatively coupled to the at least one light source and to the voltage source for selectively supplying and terminating the supply of the predetermined voltage to the at least one light source, whereby the light beam is capable of illuminating a ground surface forward of the motorcycle being ridden with its front wheel elevated above the ground surface.

### OBJECTS OF THE INVENTION

It is, therefore, one of the primary objects of the present invention to provide auxiliary lights for a motorcycle.

Another object of the present invention is to provide auxiliary lights for the motorcycle which enable the driver to see ground surface forward of the motorcycle when the front wheel of the motorcycle is elevated above the ground surface.

Yet another object of the present invention is to provide auxiliary lights for the motorcycle which are activated when the front wheel of the motorcycle is elevated above the ground surface.

A further object of the present invention is to provide auxiliary lights for the motorcycle which are manually operable by the rider.

Yet a further object of the present invention is to provide auxiliary lights for the motorcycle which are simple to retrofit on the motorcycles presently in use.

An additional object of the present invention is to provide auxiliary lights for the motorcycle which improve safety of the rider riding the motorcycle between dusk and down with the front wheel being elevated above the ground surface.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a side elevation view of a motorcycle incorporating auxiliary light assembly according to one embodiment of the present invention;

FIG. 2 is a side elevation view of a motorcycle shown in a riding position wherein its front wheel is elevated above the ground surface and which incorporates an auxiliary light assembly according to another embodiment of the present invention; and

FIG. 3 is a side elevation view of a light assembly of the present invention suitable for use on a motorcycle for providing visibility of a ground surface when the front wheel of the motorcycle is elevated above such ground surface.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

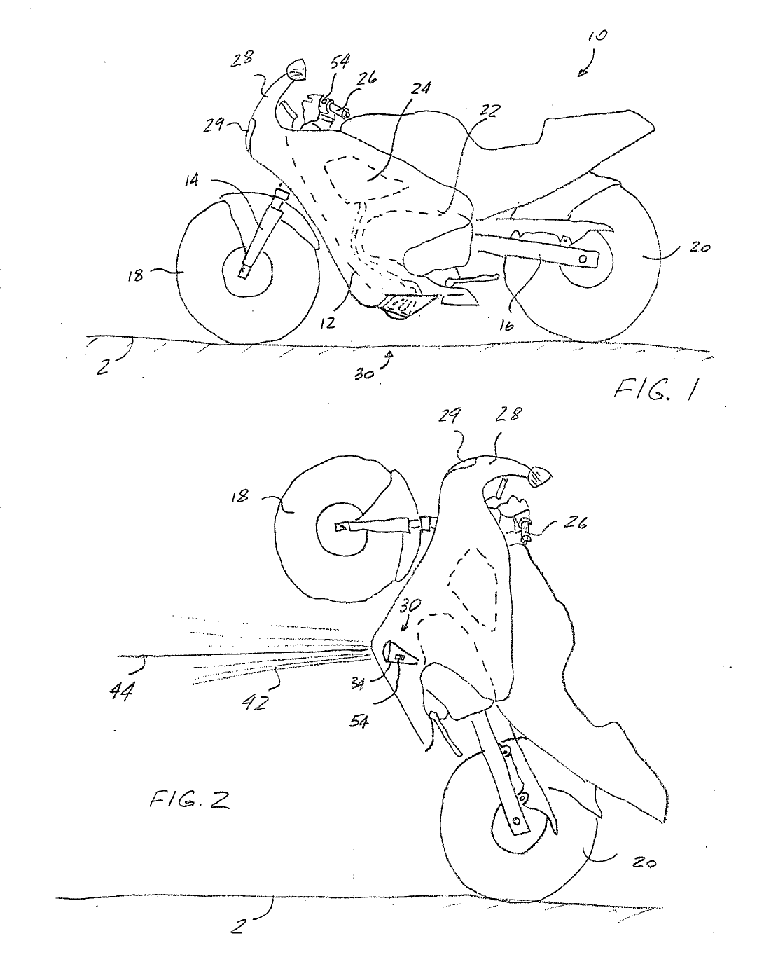

Reference is now made, to FIG. 1, wherein there is shown a motorcycle, generally designated 10. The motorcycle 10 may be any motorcycle type and preferably is a type which is known as a sport or racing motorcycle. Motorcycle 10 includes a frame 12 having a front fork 14 and a rear fork 16. A front wheel 18 is rotatably supported on the front fork 14 and a rear wheel 20 is rotatably supported on the rear fork 16. An engine 22 and a battery 24 are supported on the frame 12 in a conventional manner. Handle bars member 26 is mounted in the front portion of the motorcycle 10. The motorcycle 10 may further include a fairing 28 which is generally provided for aerodynamic purposes.

Now reference is made to FIGS. 1-3. Illustrated therein is an improvement to the motorcycle 10 which includes a light assembly, generally designated 30, which is disposed on and secured to a predetermined portion of motorcycle 10 for lighting a ground surface 2 when the motorcycle 10 is ridden with the front wheel 18 being elevated above the ground surface 2.

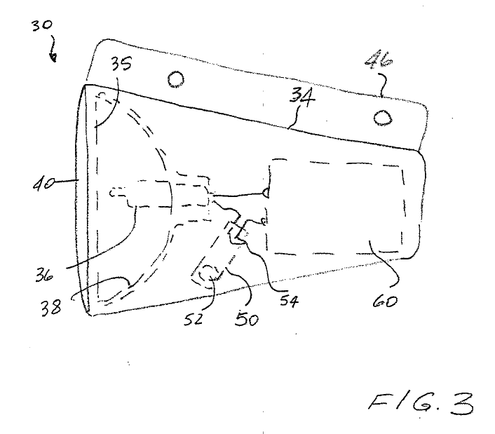

The light assembly 30 is capable of generating a light beam 42 and emitting the light beam 42 along a path 44 and in a forward direction away from the motorcycle 10. Light beam 42 has each of a predetermined intensity and a predetermined brightness. The light assembly 30 is best schematically illustrated in FIG. 3 and includes a housing 34 which has each of a predetermined shape and a predetermined size. At least one light source 36 and a mirror reflector 38 are mounted in a predetermined relationship within the housing 34. A lens 40 is secured to the housing 34 in a conventional fashion for covering its open front end 35. The lens 40 is typically made from a transparent material that allows the light beam 42 to pass through but may be provided in a variety of colors depending on user preference.

The light source 36 may be selected from a group consisting of well known super-bright light emitting diode, ultra-bright light emitting diode, light bulb and various combinations thereof. As it is well known, the light source 36 may be provided in a variety of colors depending on user preference.

Preferably, the light assembly 30 is particularly suitable for use as a fog light for providing night condition visibility. Such fog light may be of the type disclosed in U.S. Pat. No. 7,055,993 issued to Farrow et al., the teachings of which are incorporated herein by reference thereto. Although, the present invention contemplates that any other fog lights suitable for use on the motorcycle 10 will be applicable in the present invention. Additionally, U.S. Pat. No. 6,592,242 issued to Scaccia and U.S. Pat. No. 4,686,656 issued to Morishima disclose other types of auxiliary lights presently in use on a motorcycle that may be used in the present invention for illuminating a ground surface 2 forward of the motorcycle 10 being ridden with the front wheel 18 in an elevated position relative to the ground surface 2. The teachings of U.S. Pat. No. 6,592,242 and U.S. Pat. No. 4,686,656 are incorporated herein by reference thereto.

A control means is provided for selectively activating and deactivating the light means 30. In the presently preferred embodiment of the invention, the control means includes a switch means which is operatively connected to the light assembly 30. In the presently preferred embodiment of the invention, such switch means is responsive to the front wheel 18 being elevated above the ground surface 2 in order to activate the light assembly 30. Preferably, the switch means is a mercury type switch 50, which is best shown in FIG. 3. The mercury switch 50 is aligned relative to the direction of the earth's gravity so that when mercury switch 50 is tilted upwardly, when the front wheel 18 is elevated above the ground surface 2, the bead of mercury 52 touches a set of contacts 54, thus completing the electrical circuit through those contacts 54 causing activation of the light assembly 30. Tilting the mercury switch 50 in the opposite direction, when the front wheel 18 is lowered toward the ground surface 2, causes the mercury bead 52 to move away from that set of contacts 54, thus breaking that electrical circuit causing deactivation of the light assembly 30. The mercury switch 50 may be mounted external to light assembly 30 and operatively coupled thereto, but preferably, the mercury switch 50 is mounted within the housing 34.

It is within the scope of the present invention to use a well known tilt switch (not shown) instead of the mercury switch. For example, such tilt switch may be of the type disclosed in U.S. Pat. No. 5,332,876 issued to Romano et al., the teachings of which are incorporated herein by reference thereto. It is further within the scope of the present invention to employ a well known inclinometer device (not shown) of an electronic type which is operatively coupled into the control circuit (not shown) of the motorcycle 10.

Alternatively, the present invention contemplates a selector switch 56 which may be mounted on the housing 34, as best shown in FIG. 2, or within the handle bar member 26 of the motorcycle 10, as best shown in FIG. 1 and which is manually operable by the rider of the motorcycle 10. The operation of the selector switch 56 may be configured so it only activates the light assembly 30 which is then deactivated by the braking action by the driver when the light assembly 30 is coupled to the control circuit (not shown) of the motorcycle 10 which control operation of the motorcycle brake lights (not shown).

Both the light assembly 30 and the mercury switch 50 may be operably coupled to the battery 26 of the motorcycle 10 which is particularly advantageous for motorcycles 10 wherein the present invention is integrated during the manufacturing process.

Alternatively, an independent power source may be provided for supplying a predetermined voltage to the light assembly 30 enabling it to emit the light beam 42. Such independent power source is a battery 60 and preferably a rechargeable battery type. The battery 60 may be mounted external to the light assembly 30 and, preferably, the battery 60 is mounted within the housing 34. Such independent battery 60 may be advantageous for reducing effort of retrofitting the motorcycle 10 presently in use.

It will be apparent to those skilled in the art that the light assembly 30 may be mounted to any portion of the motorcycle 10 in a position for illuminating the ground surface 2 when the motorcycle 10 is ridden with the front wheel 18 being elevated above the ground surface 2. By way of example in FIG. 1, a single light assembly 32 is mounted to the bottom portion of the frame 12.

For the motorcycle 10, having the aforementioned fairing 28, the present invention contemplates use of two light assemblies 30 each secured to one side of the fairing 28, as best shown in FIG. 2. Although only one light assembly 30 is illustrated in FIG. 2, it will be apparent to those skilled in the art that the second light assembly 30 will be mounted on the opposite side of the fairing 28 and the motorcycle 10. If required, a mounting flange 46 having at least one fastener aperture 48 may be disposed on and secured to the housing 34 for attaching the light assembly 30.

It will be understood that the shape and size of the housing 34 will be determined based on the portion of the motorcycle 10 that the housing 34 is mounted to and further in view of the aerodynamic considerations when riding the motorcycle 10. It is further within the scope of the present invention to provide an auxiliary cover (not shown) for aerodynamic purposes if it is required by the shape of the housing 34 and the shape of the fairing 28 or the frame 12.

It will be further apparent to those skilled in the art, that the alignment of the light assembly 30 will be based on a preselected incline angle of the motorcycle 10 relative to the ground surface 2 in order to position light beam path 44 for illuminating the ground surface 2 in a forward direction from the motorcycle 10 in a fashion similar to operation of a headlight 29.

In use, the at least one light assembly 30 is secured to the motorcycle 10 in a position to align the light beam path 44 for illuminating the ground surface 2 when the motorcycle 2 is ridden with its front wheel 18 being elevated above the ground surface 2. The design of the mercury switch 50 is simply selected to activate the light assembly 30 when the front wheel 18 is elevated to a preselected position above the ground surface 2. Accordingly, the intensity of the light beam 42 is selected to illuminate ground surface 2 at a predetermined distance forward of the motorcycle 2.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. In combination with a motorcycle including a frame having a front fork and a rear fork, a front wheel rotatably supported on the front fork, a rear wheel rotatably supported on the rear fork and an engine supported on the frame, the improvement comprising:
(a) a light means disposed on and secured to a predetermined portion of said motorcycle and operatively coupled to a source of a predetermined voltage for illuminating a ground surface forward of said motorcycle being ridden with said front wheel elevated above ground surface; and
(b) a control means for selectively activating and deactivating said light means.

2. The improvement, according to claim 1, wherein said light means includes a pair of light assemblies attached to opposite sides of a fairing portion of said motorcycle.

3. The improvement, according to claim 2, wherein each light assembly includes a housing having an open front end, a lens covering said open front end of said housing, at least one light source and a mirror reflector being installed into said housing, said light assembly capable of generating a light beam and emitting said light beam along a light beam path and in a direction away from said motorcycle.

4. The improvement, according to claim 3, wherein said light beam has each of a predetermined intensity and a predetermined brightness.

5. The improvement, according to claim 1, wherein said light means is operatively connected to a motorcycle battery.

6. The improvement, according to claim 1, wherein said control means includes a switch means operatively connected to said light means.

7. The improvement, according to claim 6, wherein said switch means is responsive to said front wheel being elevated to a predetermined distance above ground surface in order to activate said light means.

8. The improvement, according to claim 7, wherein said switch means includes a mercury type switch.

9. The improvement, according to claim 6, wherein said switch means includes a selector switch manually operable by a rider.

10. The improvement, according to claim 9, wherein said selector switch is mounted to a handle bar member of said motorcycle.

11. The improvement, according to claim 9, wherein said selector switch is disposed within said light means.

12. The improvement, according to claim 1, wherein said improvement further includes an independent battery for supplying said predetermined voltage.

13. The improvement, according to claim 12, wherein said independent battery is mounted within said light means.

14. An auxiliary light assembly for use on a motorcycle including a frame having a front fork and a rear fork, a front wheel rotatably supported on the front fork, a rear wheel rotatably supported on the rear fork and an engine supported on the frame, said auxiliary light assembly comprising:
(a) a housing having an open front end;
(b) a lens covering said open front end of said housing;
(c) a mirror reflector installed in said housing;
(d) at least one light source operatively positioned adjacent said open front end which is coupled to a source of a predetermined voltage, said light source capable of generating a light beam and emitting said light beam along a light beam path upon supply of said predetermined voltage; and
(e) a switch means operatively coupled to said at least one light source and to said voltage source for selectively supplying and terminating a supply of said predetermined voltage to said at least one light source, whereby said light beam is capable of illuminating a ground surface forward of said motorcycle being ridden with its front wheel elevated above ground surface.

15. The auxiliary light assembly, according to claim 14, wherein said auxiliary light assembly includes said voltage source being mounted within said housing.

16. The auxiliary light assembly, according to claim 14, wherein said switch means is responsive to an elevated position of said front wheel for selectively supplying and terminating said supply of said predetermined voltage.

17. The auxiliary light assembly, according to claim 16, wherein said switch means includes a mercury type switch.

18. The auxiliary light assembly, according to claim 16, wherein said mercury switch is mounted within said housing.

19. The auxiliary light assembly, according to claim 14, wherein said switch means is manually operable from an exterior surface of said housing.
